(19) United States
(12) Patent Application Publication
(10) Pub. No.: US 2005/0185116 A1
(43) Pub. Date: Aug. 25, 2005

(54) Liquid crystal display device and video camera

(76) Inventors: Takeshi Higashi, Kagoshima (JP); Masayuki Ryu, Kagoshima (JP); Yukinori Sagawa, Kagoshima (JP); Tomoki Wakita, Kagoshima (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/035,861

(22) Filed: Jan. 14, 2005

(30) Foreign Application Priority Data
Jan. 26, 2004 (JP) P2004-017122

(51) Int. Cl. G02F 1/1335; G02F 1/1333

(52) U.S. Cl. 349/96; 349/58

(57) ABSTRACT

A liquid crystal display device includes an EVF panel; polarizing plates stuck to a plastic substrate respectively disposed in an optical path of light incident on the EVF panel and in an optical path of light exiting from the EVF panel; a top frame section having openings respectively formed in an optical path area of light incident on the EVF panel and in an optical path area of light exiting from the EVF panel; a bottom frame section engaging with the top frame section; and a flexible-circuit-board holding section; wherein the polarizing plates are disposed so as to close the respective openings, and the EVF panel is disposed apart from the polarizing plates in an approximately hermetic space formed by the bottom frame section, the top frame section, the polarizing plates, and the flexible-circuit-board holding section.

### CROSS REFERENCE TO RELATED APPLICATIONS

The present document is based on Japanese Priority Document JP2004-017122, filed in the Japanese Patent Office on Jan. 26, 2004, the entire contents of which being incorporated herein by reference.

### BACKGROUND OF THE INVENTION

1. Field of the Invention

The present invention relates to a liquid crystal display device and a video camera and, more particularly, to a liquid crystal display device and a video camera in each of which a liquid crystal panel is disposed apart from polarizing plates in an approximately hermetic space so as to suppress degradation of image quality.

2. Description of Related Art

In recent years, imaging AV devices such as digital cameras and video cameras are becoming more and more popular because of their smaller sizes, lower prices and higher pixel densities. As shown in FIG. 4, an EVF (Electronic View Finder) panel 100 provided in the view finder of an imaging AV device includes a TFT substrate 105 in which a plurality of pixels are arranged in matrix form, and a counter substrate 106 which is opposed to the TFT substrate with liquid crystal (not shown) interposed therebetween, and performs image display by applying voltages between the TFT substrate and the counter substrate to control light transmittance on the basis of the birefringence characteristics of the liquid crystal material.

In the conventional EVF panel, as shown in FIG. 4, polarizing plates 104 are respectively directly stuck to the surfaces of the TFT substrate and the counter substrate (for example, refer to Patent Document 1: Japanese Patent Application Publication No. 2000-352727). An image obtained by illuminating the EVF panel with light from a backlight 102 disposed on the back surface of the EVF panel is magnified by a magnifying lens system 103 disposed on the front surface of the EVF panel, thereby providing a desired image.

### SUMMARY OF THE INVENTION

However, in recent years, as reductions in the sizes and prices of imaging AV devices such as digital cameras and video cameras are proceeding, demands for reductions in the sizes and prices of components to be used, such as semiconductors, are becoming stronger and stronger. Accordingly, reductions in the sizes of EVF panels provided in the view finders of digital cameras, video cameras and the like are also proceeding.

As a reduction in the size of an EVF panel is proceeding as mentioned above, the magnification power of a magnifying lens system increases, so that dust adhering to the surface of the EVF panel or flaws on the panel surface become magnified and more easily visible, as a result strict control in manufacturing becomes necessary.

In addition, as mentioned above, in the conventional EVF panel, the respective polarizing plates are directly stuck to the TFT substrate and the counter substrate, but when consideration is given to the fact that the TFT substrate and the counter substrate have a thickness of approximately 1 mm as well as to the current status in which the magnification power of the magnifying lens system is being increased, there is a likelihood that the image quality of the EVF panel is degraded when dust adhering to the interface between the TFT substrate and the polarizing plate or to the interface between the counter substrate and the polarizing plate enters the focus of the magnifying lens system.

As shown in FIG. 5 by way of example, each of the polarizing plates has a multilayer structure which includes a protective layer 116 formed on an adhesive material 115 and made of TAC (triacetyl cellulose), a polarizer 117 formed on the protective layer and made of PVA (polyvinyl alcohol), a protective layer 116 formed on the polarizer and made of TAC, and a hard coat 118 formed on the protective layer. In addition, the image quality of the EVF panel may be degraded by defects formed in the polarizing plate by foreign matter entering the interface between these layers or the protective layers during the manufacture of the polarizing plate.

In general, an assembly process for assembling view finder sections of digital cameras, video cameras or the like is carried out in an environment which is not maintained at an extremely high degree of cleanness, compared to a semiconductor manufacturing process for manufacturing EVF panels, so that dust occurring in the assembly process may affect the image quality of EVF panels.

In addition, as the result of remarkable spread of digital cameras and video cameras, digital cameras and video cameras are being used in various environments such as travels, athletic meets and school plays, so that microscopic dust, which has not been adhered during manufacture and distribution, may enter the bodies of digital cameras or video cameras while they are being used by users, and may affect the image quality of EVF panels.

The present invention has been made in view of the above-mentioned drawbacks, and the present invention is to provide a liquid crystal display device and a video camera both of which can suppress adhesion of dust to a surface of an EVF panel and formation of flaws on a surface of a liquid crystal panel to suppress degradation of image quality.

In consideration of the above, the present invention provides a liquid crystal display device, which includes: a liquid crystal panel; polarizing plates respectively disposed in an optical path of light incident on the liquid crystal panel and in an optical path of light exiting from the liquid crystal panel; and a frame having openings respectively formed in an optical path area of light incident on the liquid crystal panel and in an optical path area of light exiting from the liquid crystal panel. The polarizing plates are disposed so as to close the respective openings, and the liquid crystal panel is disposed apart from the polarizing plates in an approximately hermetic space formed by the frame and the polarizing plates.

The present invention also provides a video camera including a liquid crystal display device, the liquid crystal display device includes: a liquid crystal panel; polarizing plates respectively disposed in an optical path of light incident on the liquid crystal panel and in an optical path of light exiting from the liquid crystal panel; and a frame having openings respectively formed in an optical path area of light incident on the liquid crystal panel and in an optical path area of light exiting from the liquid crystal panel. The polarizing plates are disposed so as to close the respective openings, and the liquid crystal panel is disposed apart from the polarizing plates in an approximately hermetic space formed by the frame and the polarizing plates.

In this construction, since the approximately hermetic space is formed by the frame and the polarizing plates, it is possible to suppress penetration of dust from outside, whereby it is possible to suppress adhesion of dust to the liquid crystal panel held in the approximately hermetic space. It is to be noted that this approximately hermetic space is not hermetic in a strict sense of whether it is completely shielded from outside air, but has only to be hermetic to such a degree that penetration of dust from outside can be prevented to a certain extent.

In addition, since the liquid crystal panel is disposed apart from the polarizing plates, dust is prevented from adhering to the interface between the liquid crystal panel and either of the polarizing plates, and furthermore, defects occurring in the polarizing plates become unable to be easily visible, owing to a defocus effect.

Preferably, a liquid crystal panel holding section which holds the liquid crystal panel and disposes the liquid crystal panel apart from the polarizing plates in the approximately hermetic space blocks light to be incident on a peripheral area of the liquid crystal panel. According to this construction, it is not necessary to separately add a shield plate for blocking light to be incident on the peripheral area of the liquid crystal panel, whereby it is possible to reduce the number of components required for the liquid crystal display device.

In each of the above-mentioned liquid crystal display device and video camera according to the present invention, since the liquid crystal panel is disposed in the approximately hermetic space, it is possible to suppress adhesion of foreign matter to a surface of the liquid crystal panel, which foreign matter occurs during the assembly of a digital camera, a video camera or the like (hereinafter referred to as the product), or during the distribution of the product, or during the use of the product. Accordingly, it is possible to promote an improvement in the quality of the liquid crystal panel.

In addition, since it is possible to suppress adhesion of the foreign matter occurring during the assembly to the surface of the liquid crystal panel, it is possible to simplify the work of removing dust from the surface of the liquid crystal panel in the assembly process.

Furthermore, since the liquid crystal panel is held in the approximately hermetic space, flaws are prevented from being accidentally produced during the assembly of the digital camera or the video camera, whereby flaws on the surface of the liquid crystal panel can be decreased to promote an improvement in the quality of the liquid crystal panel.

In addition, since the liquid crystal panel is disposed in the approximately hermetic space, it is possible to protect the liquid crystal panel from various external stresses such as stresses occurring during set assembly, whereby it is possible to realize a liquid crystal panel having a longer life.

In addition, since the liquid crystal panel is disposed apart from the polarizing plates, dust is prevented from adhering to the interface between the liquid crystal panel and either of the polarizing plates, whereby it is possible to promote an improvement in the quality of the liquid crystal panel.

Furthermore, since the liquid crystal panel is disposed apart from the polarizing plates, owing to a defocus effect, it is possible to reduce the influence of defects occurring in the polarizing plates during the manufacturing thereof, whereby it is possible to promote an improvement in the quality of the liquid crystal panel.

In addition, since the liquid crystal panel and the polarizing plates are not directly stuck to one another, when disposing the product, waste components of the product can be easily separated according to the classification of industrial waste, and reuse and recycle of such waste components can be easily realized.

### BRIEF DESCRIPTION OF THE DRAWINGS

FIG. 1 is a diagrammatic exploded perspective view for explaining a liquid crystal display device to which the present invention is applied;

FIG. 2 is a diagrammatic perspective view for explaining a bottom frame section of a liquid crystal display device to which the present invention is applied;

FIGS. 3A-3E are diagrammatic views for explaining a method of assembling a liquid crystal display device to which the present invention is applied;

FIG. 4 is a diagrammatic view for explaining a conventional EVF panel; and

FIG. 5 is a diagrammatic cross-sectional view for explaining the construction of polarizing plates.

### DESCRIPTION OF THE EMBODIMENT

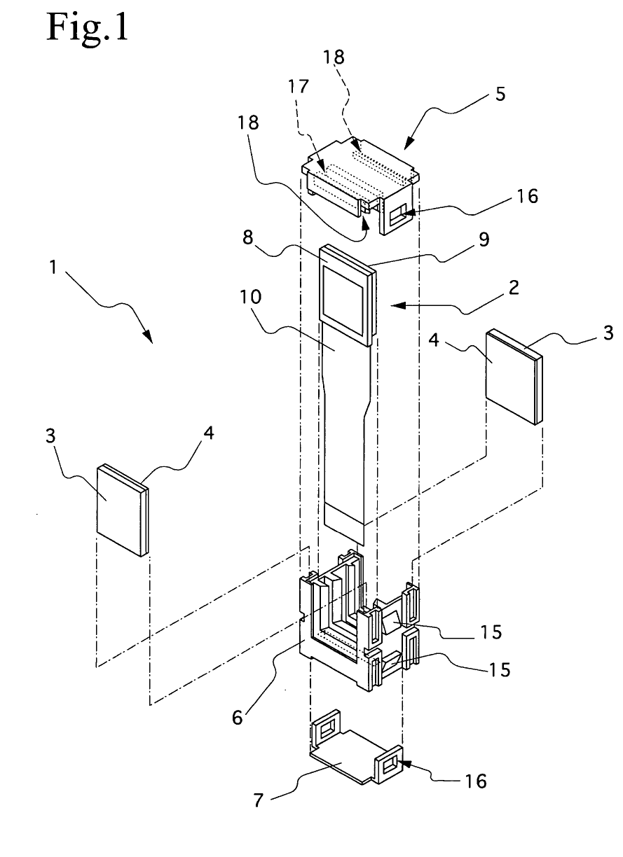

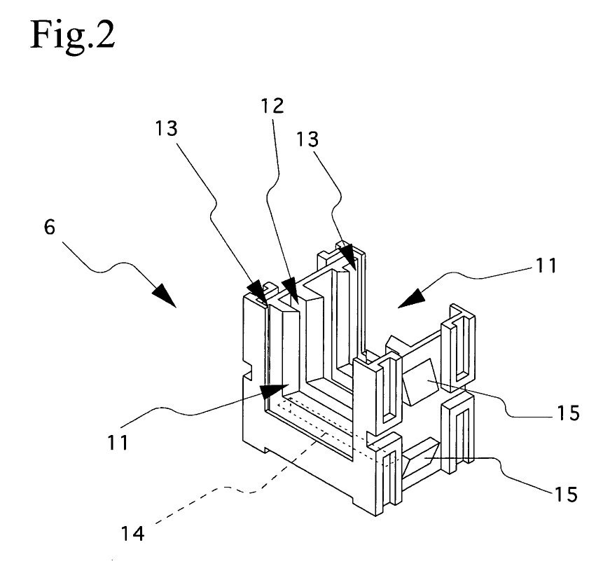

An embodiment of the present invention will be described below with reference to the accompanying drawings in order to provide a comprehensive understanding of the present invention. FIG. 1 is a diagrammatic exploded perspective view for explaining a liquid crystal display device to which the present invention is applied, and FIG. 2 is a diagrammatic perspective view for explaining a bottom frame section of the liquid crystal display device to which the present invention is applied. A liquid crystal display device 1 which is shown in FIGS. 1 and 2 includes polarizing plates 4 stuck to plastic substrates 3, a top frame section 5, a bottom frame section 6, and a flexible-circuit-board holding section 7, and an EVF panel 2 is disposed apart from both the polarizing plates 4 in a box-shaped approximately hermetic space formed by the bottom frame section 6, the top frame section 5, the polarizing plates 4 stuck to the plastic substrates 3, and the flexible-circuit-board holding section 7.

In this liquid crystal display device, the EVF panel 2 includes a TFT substrate 8 and a counter substrate 9 which are superposed on each other with a predetermined gap interposed therebetween by a sealing material, as well as liquid crystal (not shown) held in the gap between these TFT substrate 8 and counter substrate 9. A flexible circuit board 10 for providing electrical connection to an external circuit is connected to the TFT substrate 8.

The above-mentioned TFT substrate 8 includes a display area which is an effective area in which pixel aperture sections, TFT devices, interconnection lines and the like are formed, and a peripheral area which includes all areas other than the display area that correspond to a peripheral circuit area, a seal area, and an area outside the peripheral circuit and the seal area. In the display area, a multiplicity of pixels are disposed in matrix form, and signal lines such as scan lines arrayed along the row direction and data lines arrayed along the column direction are disposed to extend between adjacent ones of the pixels, and switching devices made of thin film transistors (TFTS) for driving the liquid crystal are respectively formed near the intersections of these scan and data lines.

In this liquid crystal display device, the polarizing plates 4 need not necessarily be stuck to the plastic substrates 3, but it is preferable that the polarizing plates 4 be stuck to the plastic substrates 3, because the polarizing plates 4 can be protected by the plastic substrates 3 by sticking the polarizing plates 4 to the plastic substrates 3 and inserting the obtained stuck structures into polarizing plate inserting sections (which will be described later) with the plastic substrates facing outwardly.

The bottom frame section 6 is made of a bottom plate and side plates, and openings 11 are respectively formed in an optical path of light incident on the EVF panel 2 and in an optical path of light exiting from the EVF panel 2. An EVF panel inserting section 12 which is formed between projecting sections spaced apart from each other by a distance approximately equal to the thickness of the EVF panel 2 is formed to extend on the insides of the bottom plate and the side plates. Similarly to the above, polarizing plate inserting sections 13, each of which is formed by projecting sections spaced apart from each other by a distance approximately equal to the thickness of the polarizing plate 4 stuck to the plastic substrate 3, are respectively formed to extend on the insides of the bottom plate and the side plates on both a side where light is incident on the EVF panel 2 and a side where light exits from the EVF panel 2. Each of the polarizing plate inserting sections 13 is formed in proximity to the corresponding one of the openings 11 formed between the side plates, so that the openings 11 formed between the side plates can be respectively closed by the plastic substrates 3 when the respective polarizing plates 4 stuck to the plastic substrates 3 are inserted into the polarizing plate inserting sections 13. A slit 14 is formed in the area between the projecting sections which form the EVF panel inserting section 12.

In this embodiment, since the polarizing plates 4 are disposed apart from the EVF panel 2 without being directly stuck to the surfaces of the EVF panel 2 like the conventional EVF panel, the distance from a backlight to the EVF panel 2 is long compared to the conventional EVF panel, so that there is concern that the light transmittance of the EVF panel 2 lower is likely to become low. For this reason, the EVF panel inserting section 12 is formed at a position which is selected so that the distance between the EVF panel inserting section 12 and the polarizing plate inserting section 13 on the exit side becomes shorter than the distance between the EVF panel inserting section 12 and the polarizing plate inserting section 13 on the incidence side.

The top frame section 5 is made of a top plate and side plates. The respective side plates have engagement holes 16 to engage with the corresponding ones of engagement projections 15 all of which are formed on the outsides of the side plates of the bottom frame section 6, and are constructed so that the top frame section 5 and the bottom frame section 6 can be brought into engagement with each other so that the top plate of the top frame section 5 is opposed to the bottom plate of the bottom frame section 6. In this embodiment, the top plate has an EVF panel holding section 17 which is formed at a position corresponding to the EVF panel inserting section 12 formed in the bottom frame section 6 and which is formed by projecting sections disposed apart from each other by a distance approximately equal to the thickness of the EVF panel 2. Similarly, the top plane has polarizing plate holding sections 18 which are respectively formed at positions corresponding to the polarizing plate inserting sections 13 formed in the bottom frame section 6 and each of which is formed by projecting sections disposed apart from each other by a distance approximately equal to the thickness of the corresponding one of the polarizing plates 4 0stuck to the plastic substrates 3.

Incidentally, if the EVF panel 2 can be sufficiently fixed by the EVF panel inserting section 12 formed in the bottom frame section 6, the EVF panel holding section 17 need not necessarily be formed on the top frame section 5. For a similar reason, if the polarizing plates 4 can be sufficiently fixed by the polarizing plate inserting sections 13 formed in the bottom frame section 6, the polarizing plate holding sections 18 need not necessarily be formed in the top frame section 5. However, in order to more stably fix the EVF panel 2 and the polarizing plates 4 to more reliably prevent the EVF panel 2 and the polarizing plates 4 from be moved by vibration or the like, it is preferable to form the EVF panel holding section 17 and the polarizing plate holding sections 18 in the top frame section.

Furthermore, the EVF panel inserting section 12 and the EVF panel holding section 17 are constructed so that light to be incident on the peripheral area of the EVF panel 2 can be blocked by the projecting sections which form the EVF panel inserting section 12 and the projecting sections which form the EVF panel holding section 17. In this embodiment, the EVF panel inserting section 12 and the EVF panel holding section 17 have only to be able to hold the EVF panel 2 apart from both the polarizing plates 4 in the box-shaped approximately hermetic space formed by the bottom frame section 6, the top frame section 5, the polarizing plates 4 stuck to the plastic substrates 3, and the flexible-holding section 7. The EVF panel inserting section 12 and the EVF panel holding section 17 need not necessarily be constructed so that light to be incident on the peripheral area of the EVF panel 2 can be blocked by the projecting sections which form the EVF panel inserting section 12 and the projecting sections which form the EVF panel holding section 17. However, if light to be incident on the peripheral area of the EVF panel 2 can be blocked by the projecting sections which form the EVF panel inserting section 12 and the projecting sections which form the EVF panel holding section 17, a shield plate need not be separately attached and the number of components to be used can be reduced. Accordingly, it is preferable that the EVF panel inserting section 12 and the EVF panel holding section 17 be constructed so that light to be incident on the peripheral area of the EVF panel 2 can be blocked by the projecting sections which form the EVF panel inserting section 12 and the projecting sections which form the EVF panel holding section 17.

The flexible-circuit-board holding section 7 is made of a top plate and side plates. The respective side plates have engagement holes 16 to engage with the corresponding ones of the engagement projections 15 all of which are formed on the outsides of the side plates of the bottom frame section 6, and are constructed so that the engagement holes 16 and the engagement projections 15 can be brought into engagement with each other so that the bottom plate of the bottom frame section 6 is superposed with the bottom plate of the flexible-circuit-board holding section 7. Incidentally, since the box-shaped approximately hermetic space can be formed by the top frame section 5, the bottom frame section 6, and the polarizing plates 4 stuck to the plastic substrates 3, it may be considered that the flexible-circuit-board holding section 7 need not necessarily be engaged with the bottom frame section 6. However, the slit 14 through which the flexible circuit board 10 is to be inserted is formed in the bottom plate of the bottom frame section 6, and in order to close this slit 14 and increase the hermetic degree of the box-shaped approximately hermetic space, it is preferable to engage the flexible-circuit-board holding section 7 with the bottom frame section 6.

The present embodiment has been described above with illustrative reference to an EVF panel as a liquid crystal panel, but the present invention can of course be applied to a projector panel or the like.

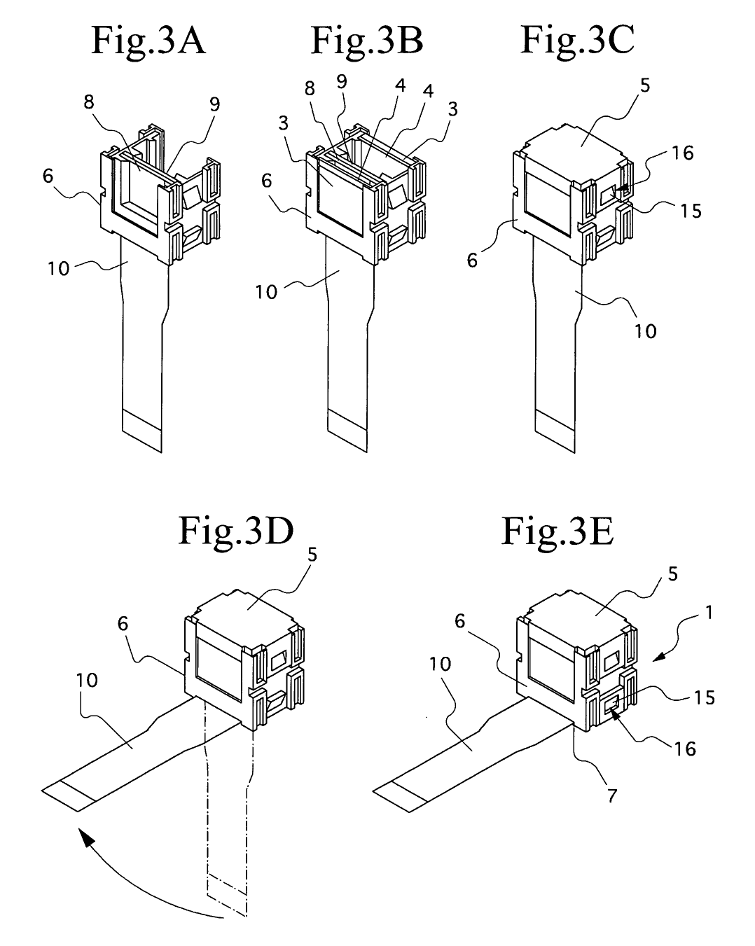

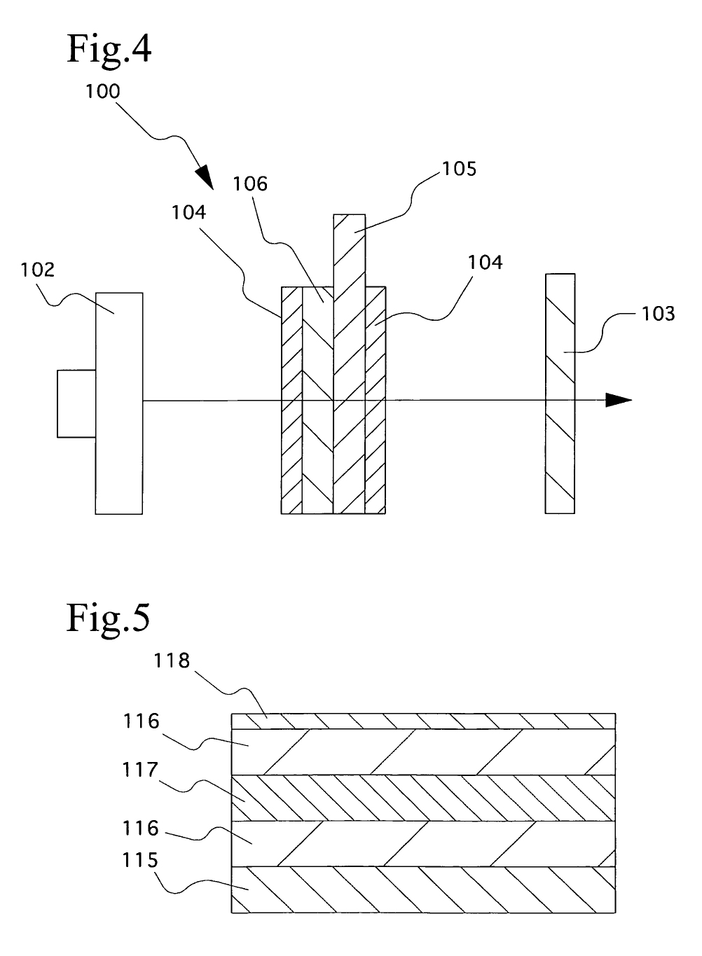

A method of assembling the above-mentioned liquid crystal display device will be described below. When the above-mentioned liquid crystal display device 1 is to be assembled, first, as shown in FIG. 3A, the flexible circuit board 10 is inserted through the slit 14 formed in the bottom plate of the bottom frame section 6, and the EVF panel 2 is inserted into the EVF panel inserting section 12. At this time, the projecting sections which form the EVF panel inserting section 12 serve the role of a guide for insertion of the EVF panel 2, so that the EVF panel 2 can be easily inserted.

Then, as shown in FIG. 3B, the polarizing plates 4 stuck to the respective plastic substrates 3 are respectively inserted into the polarizing plate inserting sections 13 with the plastic substrates 3 facing outwardly. At this time, the projecting sections which form each of the polarizing plate inserting sections 13 serve the role of a guide for insertion of the corresponding one of the polarizing plates 4.

Incidentally, the EVF panel 2 has only to be inserted into the EVF panel inserting section 12, and the polarizing plates 4 stuck to the respective plastic substrates 3 have only to be inserted into the respective polarizing plate inserting sections 13, but the polarizing plates 4 stuck to the respective plastic substrates 3 need not necessarily be inserted after the EVF panel 2 is inserted. After the polarizing plates 4 stuck to the respective plastic substrates 3 are inserted, the EVF panel 2 may also be inserted.

Then, as shown in FIG. 3C, the engagement holes 16 formed in the respective side plates of the top frame section 5 and the corresponding ones of the engagement projections 15 formed on the side plates of the bottom frame section 6 are brought into engagement with each other, whereby the bottom frame section 6 and the top frame section 5 are brought into engagement with each other so that the top plate of the top frame section 5 is opposed to the bottom plate of the bottom frame section 6.

Then, as shown in FIG. 3D, after the flexible circuit board 10 projected from the slit 14 formed in the bottom plate of the bottom frame section 6 is folded at 90 degrees, the engagement holes 16 formed in the respective side plates of the flexible-circuit-board holding section 7 and the corresponding ones of the engagement projections 15 formed on the side plates of the bottom frame section 6 are brought into engagement with each other, whereby the bottom frame section 6 and the flexible-circuit-board holding section 7 are brought into engagement with each other so that the bottom plate of the bottom frame section 6 is superposed to the bottom plate of the flexible-circuit-board holding section 7. Thus, a box-shaped liquid crystal display device 1 can be obtained as shown in FIG. 3E.

The above-mentioned embodiment has been described with illustrative reference to a transmissive type of EVF panel, but a reflective type of EVF panel may also be used if the EVF panel is disposed apart from both the polarizing plates in the box-shaped approximately hermetic space formed by the bottom frame section, the top frame section, the polarizing plates stuck to the plastic substrates, and the flexible-circuit-board holding section.

In the above-mentioned liquid crystal display device to which the present invention is applied, the EVF panel is disposed in the box-shaped approximately hermetic space formed by the bottom frame section, the top frame section, the polarizing plates stuck to the plastic substrates, and the flexible-circuit-board holding section. Accordingly, it is possible to restrain dust from entering the approximately hermetic space from outside, where by it is possible to suppress adhesion of dust to a surface of the EVF panel.

In addition, since the liquid crystal display device is constructed in a box-like shape, it is possible to promote an improvement in work efficiency during the set assembling process of incorporating liquid crystal display devices into video cameras or digital cameras. In addition, since the liquid crystal display device has a box-like shape which does not have many projections or depressions, the liquid crystal display device is rich in versatility and can be incorporated into various products.

Furthermore, since the EVF panel is disposed apart from the polarizing plates, there does not all occur the problem that dust adheres to the interface between the EVF panel and each of the polarizing plates when the polarizing plates are directly stuck to the EVF panel. In addition, owing to a defocus effect, it is possible to reduce the influence of defects occurring in the polarizing plates during the manufacturing thereof.

In addition, since the role of a shield plate is added to the projecting sections which form the EVF panel inserting section and to the projecting sections which form the EVF panel holding section, it is not necessary to perform alignment work on the EVF panel and a shield plate, so that work efficiency can be improved. Namely, during the attachment of a shield plate, alignment work needs to be performed on a TFT substrate and the shield plate in order to block light to be incident on the peripheral area of the TFT substrate. However, in the present invention, the projecting sections which form the EVF panel inserting section and the projecting sections which form the EVF panel holding section becomes able to function as a shield plate merely by engaging the bottom frame section and the top frame section with each other after inserting the EVF panel into the EVF panel inserting section disposed in the bottom frame section. Therefore alignment work of a TFT substrate and the shield plate is not necessary to be performed.

1. A liquid crystal display device comprising:
a liquid crystal panel;
polarizing plates respectively disposed in an optical path of light incident on said liquid crystal panel and in an optical path of light exiting from said liquid crystal panel; and
a frame having openings respectively formed in an optical path area of light incident on said liquid crystal panel and in an optical path area of light exiting from said liquid crystal panel; wherein
said polarizing plates are disposed so as to close said respective openings, and said liquid crystal panel is disposed apart from said polarizing plates in an approximately hermetic space formed by said frame and said polarizing plates.

2. The liquid crystal display device according to claim 1, wherein a liquid crystal display device holding section for holding and disposing said liquid panel apart from said polarizing plates in said approximately hermetic space blocks light incident on a peripheral area of said liquid crystal panel.

3. A video camera comprising a liquid crystal display device, said liquid crystal display device having:
a liquid crystal panel;
polarizing plates respectively disposed in an optical path of light incident on said liquid crystal panel and in an optical path of light exiting from said liquid crystal panel; and
a frame having openings respectively formed in an optical path area of light incident on said liquid crystal panel and in an optical path area of light exiting from said liquid crystal panel; wherein
said polarizing plates are disposed so as to close said respective openings, and said liquid crystal panel is disposed apart from said polarizing plates in an approximately hermetic space formed by said frame and said polarizing plates.
